(19) United States
(12) Patent Application Publication
(10) Pub. No.: US 2026/0001371 A1
(43) Pub. Date: Jan. 1, 2026

(54) Wheel and Drive Shaft for a Bicycle

(71) Applicant: DutchFiets B.V., Nijkerk (NL)

(72) Inventor: Johannes Alderse Baas, Amersfoort (NL)

(21) Appl. No.: 18/868,635

(22) PCT Filed: May 24, 2023
(86) PCT No.: PCT/EP2023/063980

§ 371 Date: Nov. 22, 2024

(30) Foreign Application Priority Data
May 25, 2022 (DE) 20 2022 102 924.5

(51) Int. Cl. B60B 1/00; B60B 1/02; B60B 5/02

(52) U.S. Cl. CPC B60B 1/003; B60B 1/0253; B60B 5/02; B60B 2310/204

(57) ABSTRACT

A wheel (1) for a bicycle includes a rim element (2), a plurality of pressure spoke elements (3) and a hub element (4) made of a thermoplastic plastics material. The rim element (2) is formed in a single piece together with the pressure spoke elements (3) and together with the hub element (4). A wheel hollow body (5) includes a closed wheel wall (6) where at least the rim element (2) and the pressure spoke elements (3) are hollow, and wherein the single-piece form of the wheel (1) is produced by means of rotational moulding in a rotational moulding die that can be heated externally. The wheel further including a drive shaft for the wheel.

The invention relates to a wheel for a bicycle, comprising a rim element, multiple pressure spoke elements and a hub element made of a thermoplastic, with the proviso that the rim element is formed in one piece together with the pressure spoke elements and together with the hub element.

A generally known bicycle wheel, which is constructed in several parts with a standard rim element and standard spokes, obtains its strength through a high tensile load-bearing capacity of the standard spokes. These are installed with pretensioning and are usually produced from steel. However, they would bend even with low compressive forces.

This is different from a wheel with pressure spoke elements which have a thicker cross section, for example pressure spokes on earlier vehicles with wooden wheels. In principle, a compressive force introduced by the rim element can be absorbed by means of a pressure spoke element and transferred to the hub element. The present wheel formed in one piece is provided with pressure spoke elements which are put under pressure during operation.

Compared with steel and aluminium, thermoplastic has a lower strength as a material for a wheel. The modulus of elasticity is lower than that of steel and aluminium. Likewise, the dimensional stability of thermoplastic is lower.

A known wheel made of plastic, which has pressure spoke elements, is a so-called composite wheel. This is usually made of a fibre-reinforced plastic which is reinforced for example with loose fibre constituents or with a fibre fabric, such as for example, in a carbon wheel. When such a wheel is produced, stresses and warping can occur during the production. The production of a composite wheel is complex and expensive.

The object of the invention is to propose a wheel made of a thermoplastic, which has a simpler construction and can be produced cost-effectively.

According to the invention, the object is achieved in that a hollow wheel body is formed with a closed wheel wall, wherein at least the rim element and the pressure spoke elements are formed hollow, and in that the one-piece nature of the wheel is produced by means of a rotational moulding in an externally heatable rotational mould.

The rim element of the hollow wheel body is adapted such that a bicycle tyre of the usual type can be installed. Within the meaning of the invention, the usual type includes a tubular tyre or a tubeless tyre, which are in each case ridden with air pressure. Moreover, the tyre type which is ridden with a filling material other than air, for example a foam which has a suitable resilience when deformed, is also meant. The rim element has two rim sides and a rim well. Rim flanges, which provide a bicycle tyre with purchase, are expediently provided on the rim sides.

For the rotational moulding, the thermoplastic material is poured, in the form of powder, into the rotational mould, which is closed all around for the moulding process. The rotational mould has an inner wall, which forms a negative of the shape to be moulded. The rotational mould is expediently formed as a permanent mould, which usually consists of metal, preferably aluminium. For the moulding process, the rotational mould is rotatable about at least one axis and is externally heated. The plastic powder melts in it and can be distributed over the inner wall in a viscous state as a melt. Finally, the melt solidifies on the inner wall of the rotational mould and can then be removed as a finished hollow body once the rotational mould has been opened.

The hollow wheel body for a bicycle wheel requires a dimensionally accurate shape. The inventor has discovered that it is advantageous for a wheel if plastic material, which already expands in the mould during the solidification, can expand freely inwards into the hollow rotational mould. In this way, a wheel moulded in a low-strain manner can be provided which has the dimensional accuracy and stability required for a bicycle and warps very little during and after the production. In addition, the rotationally moulded wheel is seamless because of its one-piece nature, which promotes its strength.

The hollow wheel body expediently has regions with different wall thickness of the wheel wall. In this way, the hollow wheel body can be adapted such that particularly stressed points of the wheel wall in riding operation are reinforced by more material in order to counteract cracks and breaks at these points.

The regions of the wheel wall provided with different wall thickness are generated by a heat input into the rotational mould from the outside which is different in regions. In regions heated more strongly, the powder melts more quickly and over the course of the process a greater wall thickness can be built up in order to provide the necessary strength. It surprisingly became apparent that, even for a hollow wheel body with a different wall thickness of the wheel wall, a low stress is possible, which can provide the required dimensional accuracy.

It is beneficial if the thermoplastic of the wheel wall is selected from one of the following plastics: polypropylene (PP), preferably polyethylene (PE), particularly preferably high-density polyethylene (HDPE). Economic cycles which can recycle these plastics and provide them in a form prepared for re-use already exist for the named varieties. To this end they are, for example, collected from the sea and from agriculture. They are found in fishing nets, trawl nets, nets for aquaculture or as net wrapping for binding straw bales, moreover as scaffold netting for protecting road users. The recovery of such varieties directly from everyday products which are fed back into the cycle without polluting the environment beforehand is greatly promoted with the proposed wheel.

It is very conducive to the re-use if the thermoplastic is fibre-free. Within the meaning of the present invention, fibre-free also includes a thermoplastic if it is sufficiently low-fibre to be processed such that it is suitable for a rotational moulding.

In addition, a wheel also achieves the underlying object if each pressure spoke element is rooted in the hub element and forms a trunk-shaped base, wherein the trunk-shaped base of at least one pressure spoke element extends away from the hub element in the direction of the rim element and is split into at least two branch elements, and wherein at least one branch element is connected to the rim element.

In operation, a vertical stress is exerted on the bicycle and as a consequence the wheel tends to flatten out a little when in contact with a road. At the bottom from the direction of the road a compressive force is exerted into the pressure spoke element by the rim element. The pressure spoke element transfers this compressive force as far as the hub element. When the wheel rotates in riding operation, it is useful if one of the branch elements reaches and passes through the lowest rotation point first, before the trunk-shaped base, or respectively the centre line thereof, passes through the lowest rotation point. As soon as the centre line is located at the lowest rotation point, the branch elements are in a symmetrical arrangement, with the result that both absorb a portion of the compressive force acting from below and merge into the trunk-shaped base.

The design is calculated by means of a piece of software specifically programmed for this purpose, which takes into account natural growth processes. Thus, the inventor has discovered that it is useful for the wheel to provide a structure which follows an example in nature and is stable, such as the trunk and branches of a tree. The trunk-shaped base can be arranged radially in relation to the hub element for this. The branch elements simply branch off from the trunk-shaped base such that a V-shaped arrangement of the branch elements forms towards the rim element. Moreover, it proved to be expedient if the V-shaped arrangement of the branch elements is designed symmetrical.

The rim element expediently has a nominal rim diameter in the range of from 150 mm to 650 mm. The nominal rim diameter is defined as the diameter which is measured at the lower corners of the rim well. Thus, for example, a 10″ wheel has a nominal rim diameter of 152 mm according to ETRTO (European Tyre and Rim Technical Organisation) and a 28″ wheel generally has a nominal rim diameter of 622 mm according to ETRTO.

The two branch elements and the trunk-shaped base of the pressure spoke element expediently meet in a node, wherein the node lies on a circle diameter which is arranged coaxially relative to the hub element, wherein the size of the circle diameter lies in the range of from 0.4 to 0.6 times the external diameter of the rim element.

The hub element preferably has a hollow cylindrical hub sleeve.

Furthermore, a wheel also achieves the underlying object if the hub element has a hollow cylindrical hub sleeve, the internal diameter of which is at least as large as the length of the hub sleeve in its axial direction.

This measure is based on the inventor's knowledge, according to which a relatively large diameter of the hub sleeve in relation to the diameter of the wheel serves to strengthen the wheel. The pressure spoke elements are shorter to the extent to which the radius of the hub sleeve is enlarged.

How thick the diameter of a drive shaft for the wheel has to be if this drive shaft is also made of plastic can be assumed to be a reference point for the extent of the diameter of the hub sleeve.

After consideration, it is assumed that an expedient extent for the hollow cylindrical diameter of the hub sleeve lies in the range of the factor 1.0 to 2.0, in relation to the length of the hub sleeve.

Disregarding the length of the hub sleeve, the inventor starts from a hollow cylindrical diameter of the hub sleeve in the range of from 90 mm to 140 mm for an example 28″ wheel, which has an external diameter of 622 mm.

In addition, the hollow cylindrical hub sleeve of the hub element is expediently adapted optionally to cooperate either with a drive shaft or with a fixed wheel axle.

At least one means with which a torque can be transmitted is advantageously provided on the hub element.

In a simple manner, the means for transmitting the torque comprises multiple threaded holes, which are arranged distributed around the circumference of the hub sleeve at an edge of the hub element.

The means for absorbing a torque is advantageously adapted to fasten a drive shaft to the hub element and/or to fasten a brake disc to the hub element. The proposed internal threads at the edge of the hub element can be arranged in a metal element, wherein the metal element is expediently integrated in the thermoplastic of the hollow wheel body.

It is helpful if the wheel is provided with a data storage element, preferably with an RFID storage element. Items of material information and/or data relating to the production of the wheel, in particular about the plastic material used, can preferably be stored therein. If a bicycle wheel at the end of its life returns to the economic cycle, stored items of information can help to process and re-use the plastic as a homogeneous raw material.

In a preferred embodiment, six pressure spoke elements are provided for the proposed wheel.

The wheel expediently has an envelope volume which lies in a range of from 3.5 litres to 5 litres, preferably in the range of from 3.8 litres to 4.4 litres and particularly preferably in the range of from 4 litres to 4.2 litres.

By envelope volume of the wheel within the meaning of the invention is meant the volume of the outer surface of the wheel (without bicycle tyre), with the proviso that all openings present are interpreted as closed regions of surface and attributed to the outer surface, e.g., any opening for a tube valve is interpreted as a closed region of surface.

Moreover, seen individually or in combination with the named envelope volume, it is advantageous if the wheel has a weight in the range of from 1.3 kg to 2.2 kg, preferably in the range of from 1.6 kg to 1.9 kg and particularly preferably in the range of from 1.7 kg to 1.8 kg.

The wheel expediently has, in relation to its envelope volume, a specific weight in the range of from 0.26 kg/litre to 0.63 kg/litre.

The invention furthermore includes a drive shaft for the wheels proposed above. The drive shaft is expediently adapted for a one-sided mounting on a bicycle frame, preferably a one-sided rear wheel support of a bicycle frame.

A gear wheel element, which can cooperate with a drive means of a bicycle, is expediently arranged on the drive shaft.

The gear wheel element advantageously comprises a sprocket for a bicycle chain or a tooth lock washer for a toothed belt or a gear wheel for a drive shaft.

The drive shaft advantageously comprises two shaft elements, which are arranged and can be connected in a line.

It is favourable if one shaft element is formed as a wheel support shaft element and the other is formed as a supporting shaft element.

Both shaft elements expediently comprise complementary connection means, which are adapted to transfer a rotational movement in at least one direction of rotation between the two shaft elements. The connection means can be complementary threads or complementary profiles, such as a spline shaft profile and a spline hub profile.

The gear wheel element is preferably arranged on the wheel support shaft element. The wheel support shaft element can be provided with a support element, on which a gear wheel element can be installed in a rotationally fixed manner.

Furthermore, the gear wheel element can be integrated in one piece in the drive shaft, or respectively in one of the shaft elements, preferably in the wheel support shaft element.

Proposed is a bicycle component part from the group: wheel and drive shaft, comprising a one-piece hollow body with a component part wall surrounding its cavity, wherein the component part wall of the hollow body is produced from a thermoplastic in a closed mould, wherein the component part wall has a one-piece nature, which is produced by means of a rotational moulding in an externally heatable mould designed for the rotational moulding, with the additional proviso that a foam is arranged in the cavity, and that the foam extends as a foam layer over the inside of the component part wall or completely fills the cavity.

Finally, another bicycle component part is proposed from the group: wheel and drive shaft is proposed. This bicycle component part comprises a one-piece hollow body with a component part wall surrounding its cavity, wherein the component part wall of the hollow body is produced from a thermoplastic in a closed mould and has a one-piece nature, which is produced by means of a rotational moulding in an externally heatable mould provided for the rotational moulding, with the additional proviso that a foam is arranged in the cavity, and that the foam extends as a foam layer over the inside of the component part wall or completely fills the cavity.

The process of foaming is advantageously carried out inside the cavity. The process of foaming is preferably carried out when the rotational moulding of the component part wall is still in progress, with molten thermoplastic for the rotational moulding of the component part wall. A starting material of the foam is poured into the cavity forming, in order to foam therein, using at least one suitable pouring means which is provided on the mould. The starting material is easily poured into the same opening of the mould as the thermoplastic for the component part wall beforehand. A supply tube can be used which can be inserted into the mould. It can be inserted so deeply that it penetrates the layer of molten thermoplastic which has already formed on the inside of the mould. The pouring of the foam starting material can be easily carried out when the rotational movement of the mould is stopped. The rotational movement of the mould is not only a circular movement, but advantageously a complex three-dimensional movement in space. To pour the foam starting material, it is possible for example to stop a component of the complex movement in order then to be able to insert the supply tube into the pouring means of the mould and pour the foam starting material into the cavity remaining.

In principle, the process of foaming can be a physical process or the process of foaming is based on a chemical reaction. The starting material of the foam is expediently poured in the form of a granular material using the pouring means of the mould until it reaches the cavity forming. For the chemical foaming, the granular material of the starting material can be easily provided with a foaming agent. The foaming agent is preferably designed such that it can evaporate through heat input. If the starting material also melts through the heat input, the evaporated foaming agent can foam the molten starting material.

The invention is illustrated hereafter by way of example in a drawing and described in detail with reference to several figures. There are shown in:

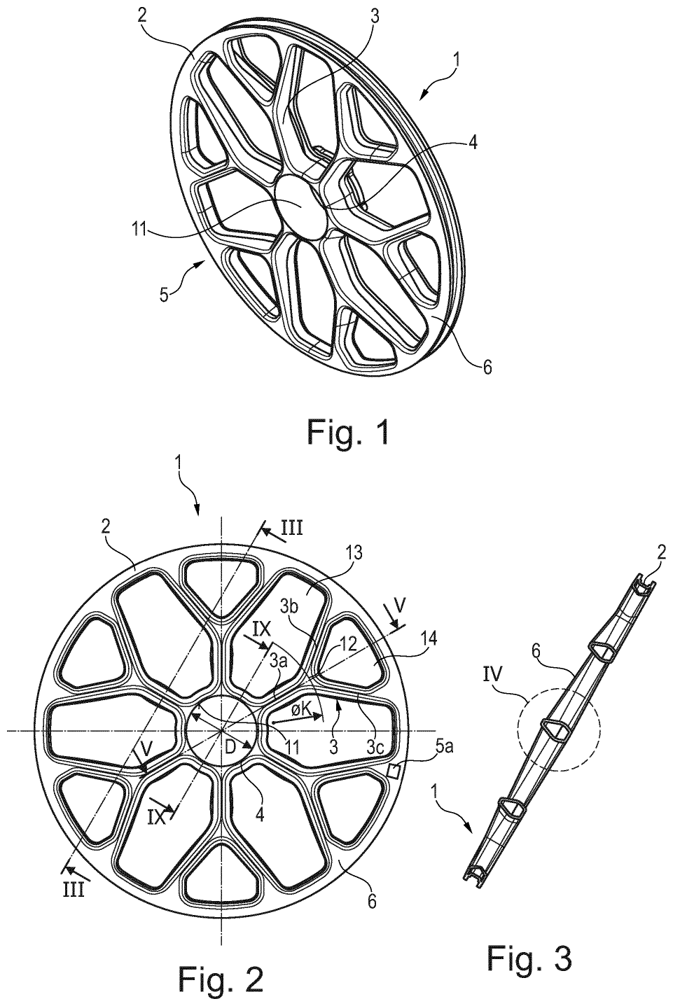

FIG. 1 a perspective view of a wheel according to the invention,

FIG. 2 a side view of the wheel according to FIG. 1,

FIG. 3 a cross section along the cutting line III-III marked in FIG. 2,

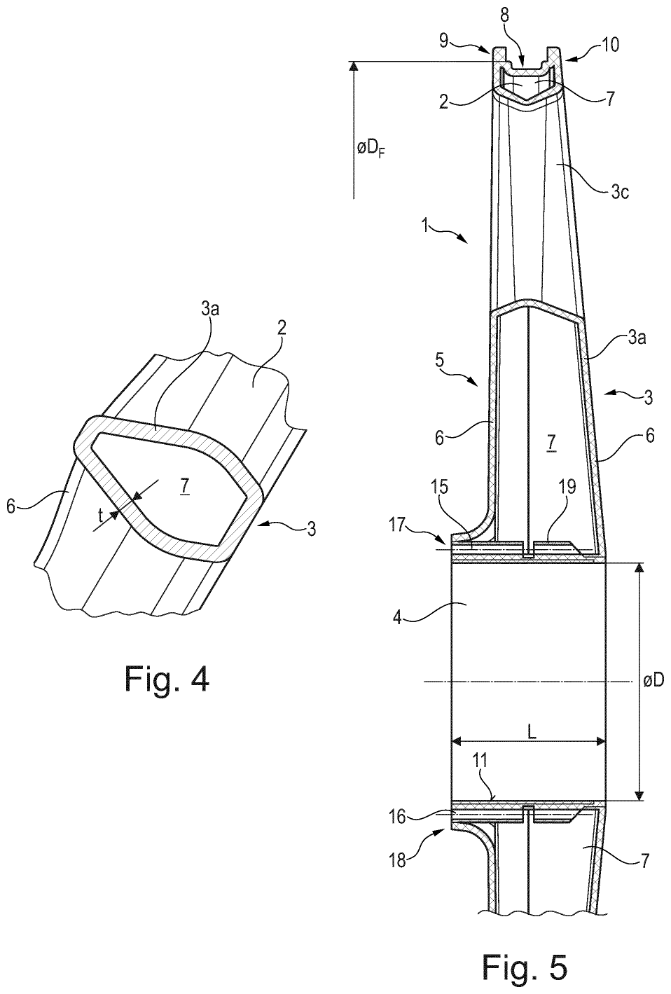

FIG. 4 an enlarged representation of the section IV, as marked in FIG. 3,

FIG. 5 a sectional representation in sections along the cutting line V-V marked in FIG. 2,

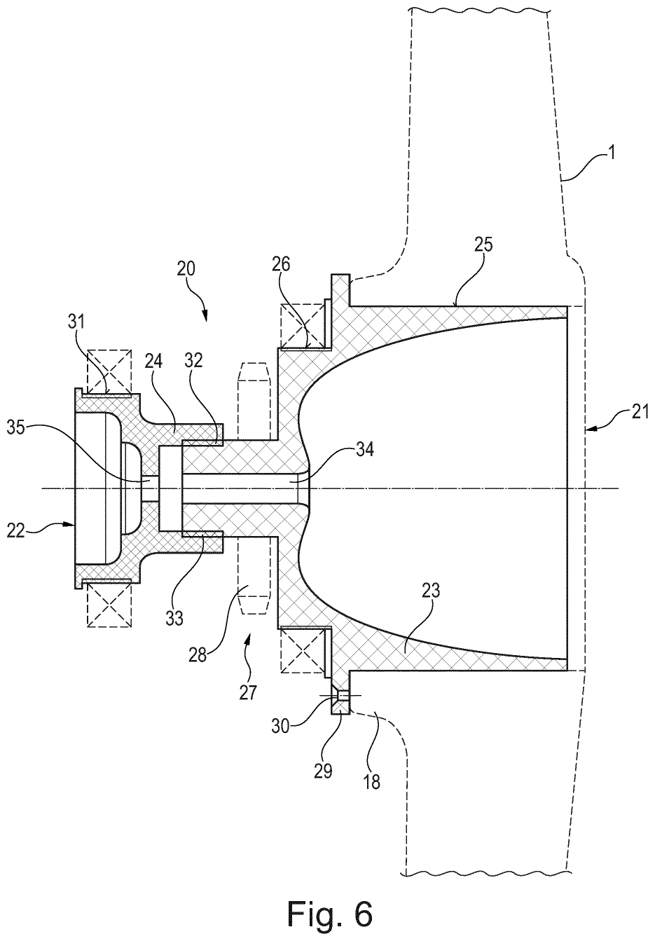

FIG. 6 a drive shaft according to the invention in cross section,

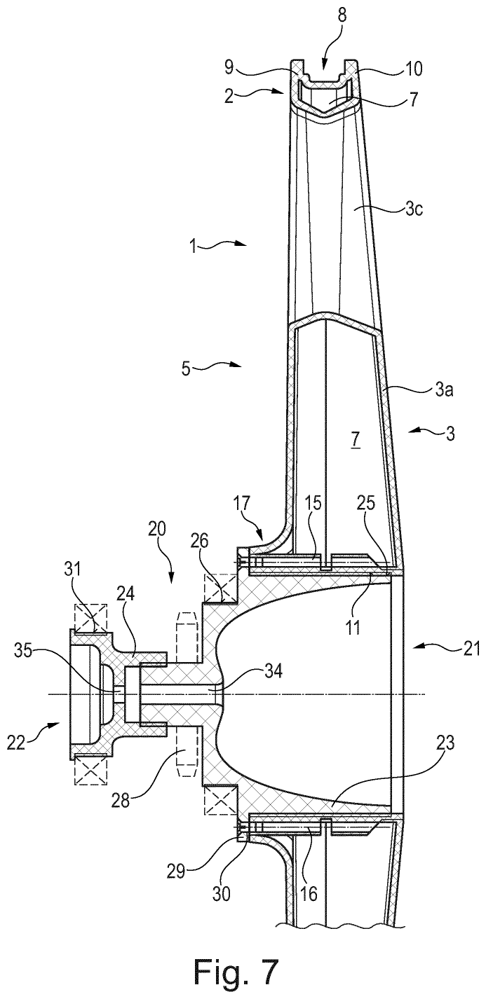

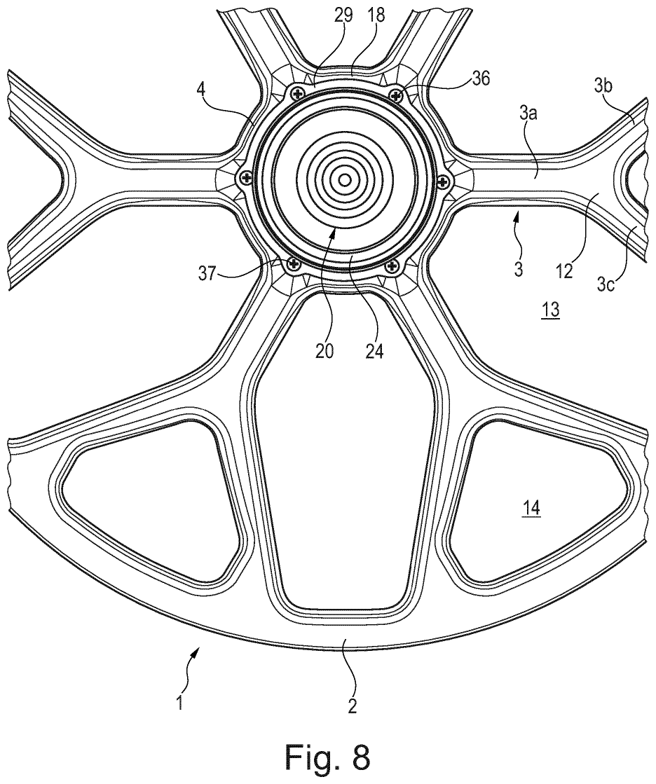

FIG. 7 a representation of the wheel according to FIG. 5 in the installed state on the drive shaft according to FIG. 6,

FIG. 8 an enlarged side view in sections of the wheel with installed drive shaft according to FIG. 7,

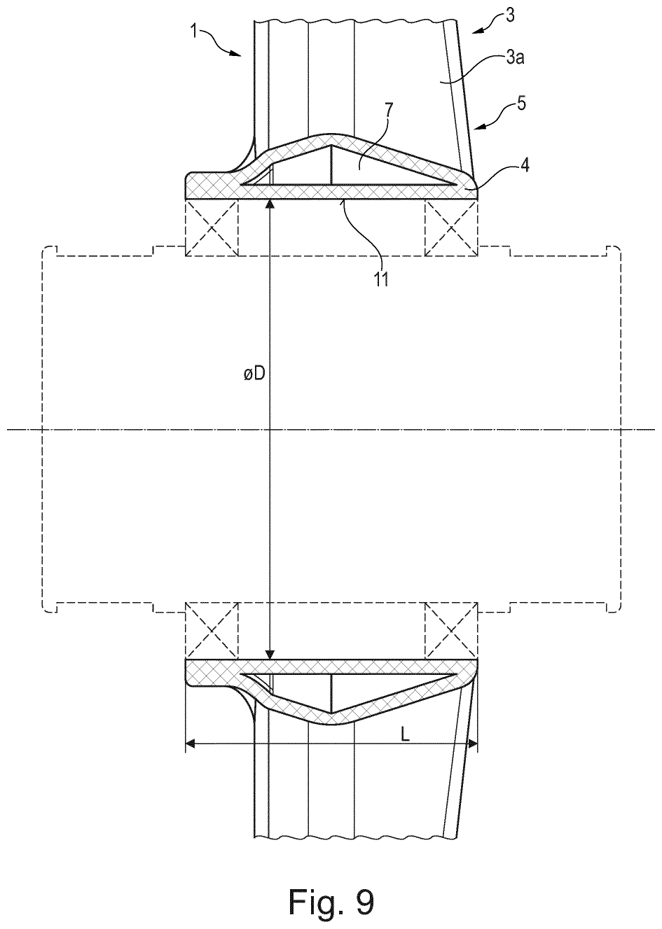

FIG. 9 a sectional representation in sections along cutting line IX-IX, as marked in FIG. 2,

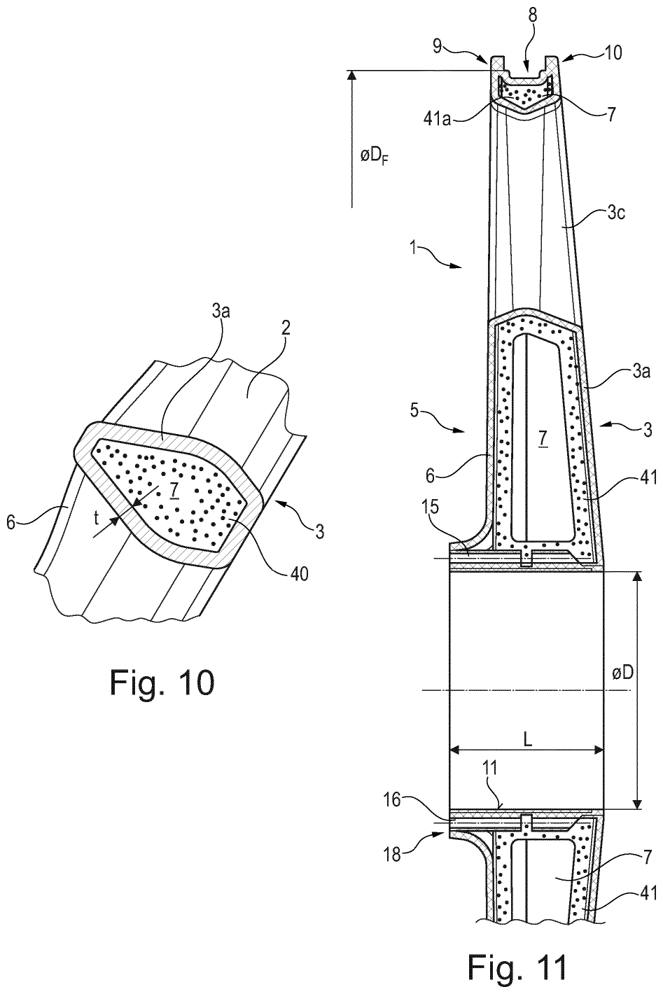

FIG. 10 an alternative embodiment of the wheel with reference to an enlarged representation of a section, such as the section in FIG. 4, as a bicycle component part with rotationally moulded hollow body and a foam filling,

FIG. 11 a further alternative embodiment of the wheel with reference to a sectional representation in sections, such as that in FIG. 5, as a bicycle component part with rotationally moulded hollow body with a layer of foam.

FIG. 1 shows a wheel 1 according to the invention in a perspective view. The wheel 1 comprises, as constituents, a rim element 2, multiple pressure spoke elements 3 and a hub element 4. As a whole, i.e., comprising all constituents, the wheel 1 is formed in one piece, namely of a thermoplastic. It is formed as a hollow wheel body 5 with a closed wheel wall 6. In the example, the rim element 2, the pressure spoke elements 3 and also the hub element 4 are hollow, such that a common cavity 7 is formed. The wheel wall 6 is seamless. The one-piece nature of the wheel 1 is produced by means of a rotational moulding in an externally heatable rotational mould.

In particular, the pressure spoke elements 3 have a specific structure. Each pressure spoke element 3 is rooted in the hub element 4 with a trunk-shaped base 3a, namely a total of six pressure spoke elements 3. They extend in a radial direction from the hub element 4 in the direction of the rim element 2. Each pressure spoke element 3 symmetrically splits into two branch elements 3b and 3c, with the result that a total of twelve branch elements are connected to the rim element 2. The proposed structure follows the example in nature of a tree with a trunk and branches, in order to provide improved stability. The symmetrically arranged branch elements 3b/3c are arranged in a V shape relative to each other and adjoin the rim element 2 with the two ends of the V shape.

The wheel shown here has an envelope volume of 4.1 litres with a tolerance of ±0.1 litres. Its weight lies in the range of from 1.6 kg to 1.9 kg.

The rim element 2 is adapted to receive a bicycle tyre of the usual type, such as a pneumatic tyre in the form of a tubular tyre or a tubeless pneumatic tyre. Bicycle tyres with a filling other than air, for example foam, can also be used. These involve a hollow chamber rim element with a deep rim well 8 and with rim sides 9 and 10, which each have a rim flange (not represented) in order to fix a bicycle tyre to the rim cross section.

Furthermore, the hub element 4 represents a specific structure of this wheel 1, because the hub element 4 is formed as a large hollow cylindrical hub sleeve 11, the internal diameter D of which is as least as large as the length L of the hub sleeve 11 in its axial direction. In the present example, the internal diameter D of the hub sleeve is 120 mm and its length L is 77 mm. In this way, the hub sleeve 11 is adapted to optionally receive either a drive shaft, which preferably consists of plastic, or to receive bearing elements for mounting the wheel 1 on a fixed wheel axle, which preferably consists of plastic. Both a wheel axle and a drive shaft require a larger cross section than a usual wheel axle or drive shaft constructed from steel or aluminium. The internal diameter D of the hub sleeve 11 is therefore geared in particular to the diameter required by a drive shaft if it is made of plastic. In addition, it is taken into account that a drive shaft can be adapted such that it is mounted on one side, which is accompanied by the fact that the wheel 1 is freely accessible from one side and can be installed like a wheel of a car.

In the present example, the internal diameter D of the hub sleeve 11 is larger than the length L of the hub sleeve 11 in its axial direction by a factor of 0.7.

FIG. 2 shows the wheel 1 according to FIG. 1 as a side view. The stable structure of each pressure spoke 3 can be clearly seen. Uniformly distributed on the circumference of the hub element 4, six pressure spokes 3 are attached and extend with their trunk-shaped base 3a radially outwards as far as a node 12, at which they split into the two branch elements 3b and 3c. Thus, a total of twelve branch elements merge into the rim element 2. The node lies on a circle diameter K which is half as large as the nominal rim diameter D_{F} in the example.

An RFID storage element 5a is provided on the hollow wheel body 5 in order to store items of information about the wheel 1 therein, in particular about the plastic material used. If a bicycle wheel at the end of its life returns to the economic material cycle, stored items of information can help to process the plastic as a homogeneous raw material in order to re-use it.

Two adjacent pressure spoke elements 3 form a large through opening 13 together with a section of the rim element 2 and a section of the hub element 4. A total of six large through openings 13 result on the wheel 1. Moreover, the two branch elements 3b and 3c of a pressure spoke element 3 in each case form a small through opening 14 together with a section of the rim element 2, thus six small through openings are likewise formed for the entire wheel 1. In addition to the stability of the structure, an aesthetically appealing design of the wheel 1 thus results.

FIG. 3 shows a cross section along the cutting line III-III. The pressure spoke element 3 is cut perpendicular to its radial extent and the cutting line is arranged slightly inclined with respect to the longitudinal extent of the branch elements 3b and 3c.

The pressure spoke element 3 is represented enlarged in FIG. 4. The wall thickness t is marked on the hatched cross section of the pressure spoke element 3. The hatched cross section forms the cross-sectional area of the pressure spoke element 3 which has an influence on the strength according to the science of the strength of materials. The cross section is hexagonally shaped as an irregular hexagon with different side lengths. The sides which are oriented in the axial direction are formed longer than the sides of the hexagonal cross section arranged parallel to the rolling direction of the wheel. The so-called area moment of inertia of such a cross-sectional area relates to how great the resistance of this cross-sectional area to an external deformation is. The shape of the hatched cross-sectional area represented here has proved to be expedient in order to bear a static vertical load which acts on a wheel 1. Moreover, the hatched cross-sectional area is expedient for transmitting a torque, on the one hand a driving torque, when the wheel 1, as a driven wheel 1, has to transmit a torque to a road, or for transmitting a braking torque, if a braking torque is transmitted via the rim element 2 to the hub element 4 because, for example, a disc brake is provided on the hub element 4.

FIG. 5 is a sectional representation in sections of the wheel 1 along the cutting line V-V, as marked in FIG. 2. The cut runs through the trunk-shaped base 3a of the pressure spoke element 3 and shows the cross section of the rim element 2. Moreover, the nominal rim diameter D_{F} is marked. In addition, FIG. 5 shows threaded holes 15 and 16 with internal threads which are provided as means 17 for absorbing a torque. As can best be seen in FIG. 8, these are two of a total of six threaded holes which are arranged uniformly at an edge 18 of the hub element 4 in order to connect the wheel 1, for example, to a drive shaft. Alternatively, a brake disc can be fastened to the wheel 1 by means of these threaded holes 15/16.

In the present example, the threaded holes 15/16 are arranged in an annular aluminium element 19, which has been integrated in the thermoplastic of the hollow wheel body 5 by means of rotational moulding.

FIG. 6 shows a drive shaft 20 according to the invention in cross section. It is adapted for a one-sided mounting on a bicycle frame, preferably a one-sided rear wheel support of a bicycle frame. The drive shaft 20 comprises two shaft elements 21 and 22, which are arranged and can be connected to each other in a line. One shaft element 21 is designed as a wheel support shaft element 23 and the other is designed as a supporting shaft element 24.

The wheel support shaft element 23 has a cylindrical wheel support surface 25, which supports a wheel according to the invention, which is indicated as a dashed line in FIG. 6. The wheel sits with the hub sleeve of its hub element on the cylindrical wheel support surface 25. Furthermore, the wheel support shaft element 23 comprises a bearing ledge 26 for a roller bearing, which is likewise indicated as a dashed line. The roller bearing has an inner ring, which can be installed on the bearing ledge 26.

In operation, the inner ring rotates together with the drive shaft 20 and the wheel 1 drawn in dashed. The associated outer ring of the roller bearing is arranged fixed in a bicycle frame in the installed state. Furthermore, a gear wheel element 27 is provided, which is arranged on the wheel support shaft element 23 in the present example. It is formed as a tooth lock washer and is used for a toothed belt, which can transfer a drive movement to the drive shaft 20.

The tooth lock washer 28 is connected to the wheel support shaft element 23 in a rotationally fixed manner and can be replaced. Alternatively, the gear wheel element 27 can be integrated in one piece with the wheel support shaft element 23 of the drive shaft 20.

A flange 29, which has through-holes 30 for screws, is provided between the bearing ledge 26 and the wheel support surface 25 of the wheel support shaft element 23. The through-holes 30 serve to fasten the drive shaft 20 to the hub element 4 of the wheel 1 and make it possible to transmit torque from the drive shaft 20 into the wheel 1 for the purpose of drive or, in the reverse direction, in order to achieve a braking effect, for example using a brake disc (not shown). The flange 29 is provided with a total of six through-holes 30, which are uniformly distributed on the circumference of the flange 29. The arrangement of the six through-holes 30 coincides with the hole pattern of the six threaded holes which are provided at the edge 18 of the hub element 4 of the wheel 1.

The supporting shaft element 24 has a cylindrical bearing seat 31 for a roller bearing. This roller bearing is also indicated as a dashed line in FIG. 6. It likewise has an inner ring which is arranged on the bearing seat 31 of the supporting shaft element 24 and rotates together with the drive shaft 20 and the wheel 1 in operation. An associated outer ring of this roller bearing is then likewise arranged fixed in a bicycle frame.

The wheel support shaft element 23 is connected to the supporting shaft element 24. The two shaft elements have, as complementary connection means, complementary profiles which make it possible to transmit torque. The wheel support shaft element 23 is provided with a spline shaft profile 32 and the supporting shaft element 24 is provided with a hub profile 33 matching this. Furthermore, the wheel support shaft element 23 and the supporting shaft element 24 are each provided with a central through opening 34 and 35, respectively. In the fitted-together state the through openings 34 and 35 are arranged coaxial and can receive a screw connection (not represented). The two shaft elements 20 and 21 can be connected to each other and secured in the axial direction by means of the screw connection comprising a screw that has been pushed through and a nut.

FIG. 7 shows the wheel 1 according to the invention in sections, as in FIG. 5 but in the installed state on a drive shaft 20 according to FIG. 6. The flange 29 of the wheel support shaft element 23 is fastened to the wheel 1 with screws 36 and 37. The screws 36 and 37 push into the through-holes 30 of the flange 29 and they are screwed into the threaded holes 15 and 16, respectively, at the edge 18 of the hub element 4 and in this way make it possible to transmit torque between drive shaft 20 and wheel 1.

FIG. 8 shows, enlarged, a side view in sections of the wheel 1 with installed drive shaft 20. In this side view, the six screws 36 and 37 which fasten the flange 29 of the wheel support shaft element 23 to the hub element 4 can be seen. The hole pattern is arranged such that the threaded holes are in each case located at those points on the edge 18 of the hub element 4 from where the pressure spoke elements 3 extend radially outwards.

FIG. 9 shows the wheel 1 as a sectional representation in sections along the cutting line IX-IX, as marked in FIG. 2. The hub element 4 is cut at a point remote from the pressure spoke element. The representation shows that the hub element 4 is also designed hollow. Other than that, a wheel axle is drawn in dashed by way of example. The wheel axle is installed fixed in a bicycle frame, or respectively the front fork thereof. Furthermore, two roller bearings, which comprise an inner ring and an outer ring, are likewise indicated dashed. In this example, the roller bearings sit with their inner rings on the fixed wheel axle. By contrast, the outer rings sit in the wheel 1, namely in the hub sleeve 11 of the hub element 4, with the result that, in this example, the outer rings rotate together with the wheel 1.

FIG. 10 represents a view of an alternative bicycle component part. By way of example, the structure of this alternative bicycle component part is explained with reference to the region of a pressure spoke element 3 of a wheel, as in FIG. 4. The component part comprises a hollow wheel body 5, which is produced in one piece and has a component part wall, here a wheel wall 6, which surrounds a cavity 7. The wheel wall 6 is produced from a thermoplastic in a closed mould. The one-piece nature of the wheel wall 6 is produced by means of a rotational moulding in an externally heatable mould provided for the rotational moulding. The alternative of FIG. 10 differs from the example of FIG. 4 in that a foam 40, which fills the cavity 7 in the present example (foam filling), is additionally arranged in the hollow wheel body 5.

The process of foaming was carried out inside the cavity, while the rotational moulding of the wheel wall 6 was still in progress, with molten thermoplastic for the wheel wall 6. The starting material of the foam was poured into the mould as a granular material via a suitable pouring means. The granular material used can be foamed by a chemical reaction. For this purpose, it contains a foaming agent. In the present example, the foaming agent is designed to evaporate through heat input. Through the heat input the starting material is likewise melted, which subsequently foams due to the evaporating foaming agent.

FIG. 11 represents a further example of an alternative bicycle component part. By way of example, it is also explained for this alternative with reference to a wheel how the alternative bicycle component part is constructed and how it is produced. The example is based on the representation of the wheel of FIG. 5. According to FIG. 11, the bicycle component part is again formed as a one-piece hollow body, here the hollow wheel body 5 with a component part wall, namely the wheel wall 6. The wheel wall 6 surrounds a cavity 7. It is produced from a thermoplastic in a closed mould. The one-piece nature of the wheel wall 6 is again produced by means of a rotational moulding in a mould which is externally heatable for the rotational moulding.

The alternative of FIG. 11 differs from the example of FIG. 5 and from the example of FIG. 10 in that a foam 41, which in the present example coats the component part wall of this bicycle component part, namely a wheel wall 6, on its inside facing the cavity 7 (foam layer), is additionally arranged in the hollow wheel body 5. Although the cavity 7 of the hollow wheel body 5 thereby decreases, it does not disappear in all regions. In the region 41a, the cross section of the cavity 7 is, however, so small that a layer thickness which no longer leaves a cavity has resulted there in regions in the present example, and therefore a foam filling 41a has formed in this region.

### LIST OF REFERENCE NUMBERS

1 wheel
2 rim element
3 pressure spoke element
3a trunk-shaped base
3b branch element
3c branch element
4 hub element
5 hollow wheel body 5a RFID storage element
6 wheel wall
7 cavity
8 rim well
9 rim side
10 rim side
11 hub sleeve
12 node
13 through opening (large)
14 through opening (small)
15 threaded hole
16 threaded hole
17 means
18 edge (hub element)
19 annular aluminium element
20 drive shaft
21 shaft element
22 shaft element
23 wheel support shaft element
24 supporting shaft element
25 cylindrical wheel support surface
26 bearing ledge
27 gear wheel element
28 tooth lock washer
29 flange
30 through-hole
31 bearing seat
32 spline shaft profile
33 hub profile
34 through opening
35 through opening
36 screw
37 screw
40 foam filling
41 foam layer
41a foam filling
D internal diameter
L length (hub sleeve)
D_{F} nominal rim diameter
K circle diameter (node)

1. A wheel (1) for a bicycle, comprising a rim element (2), multiple pressure spoke elements (3) and a hub element (4) made of a thermoplastic, with the proviso that the rim element (2) is formed in one piece together with the pressure spoke elements (3) and together with the hub element (4), wherein a hollow wheel body (5) is formed with a closed wheel wall (6), in that at least the rim element (2) and the pressure spoke elements (3) are formed hollow, and in that the one-piece nature of the wheel (1) is produced by means of a rotational moulding in an externally heatable rotational mould.

2. The wheel according to claim 1, wherein the hollow wheel body (5) has regions with different wall thickness (t) of the wheel wall (6).

3. The wheel (1) according to claim 2, wherein the regions of the wheel wall (6) that are provided with different wall thickness (t) are generated by a heat input into the rotational mould from an outside which is different in regions.

4. The wheel (1) according to one of claim 1, wherein the thermoplastic of the wheel wall (6) is selected from one of the following plastics: polypropylene (PP), polyethylene (PE), and high-density polyethylene (HDPE).

5. The wheel (1) according to claim 1, wherein the thermoplastic is fibre-free.

6. A wheel (1) for a bicycle, comprising a rim element (2), multiple pressure spoke elements (3) and a hub element (4) made of a thermoplastic, the rim element (2) is formed in one piece together with the pressure spoke elements (3) and together with the hub element (4), wherein each pressure spoke element (3) is rooted in the hub element (4) and forms a trunk-shaped base (3a), in that the trunk-shaped base (3a) of at least one pressure spoke element (3) extends away from the hub element (4) in the direction of the rim element (2) and is split into at least two branch elements (3b, 3c), and in that at least one branch element (3b, 3c) is connected to the rim element (2).

7. The wheel (1) according to claim 6, wherein the rim element (2) has a nominal rim diameter in the range of from 150 mm to 650 mm.

8. The wheel (1) according to claim 7, wherein the two branch elements (3b, 3c) and the trunk-shaped base (3a) of the pressure spoke element (3) meet in a node (12), the node (12) lies on a coaxial circle diameter (K) relative to the hub element (4), and the size of the circle diameter (K) lies in the range of from 0.4 to 0.6 times a nominal rim diameter (DF) of the rim element (2).

9. The wheel (1) according to claim 1, wherein the hub element (4) has a hollow cylindrical hub sleeve (11).

10. A wheel (1) for a bicycle, comprising a rim element (2), multiple pressure spoke elements (3) and a hub element (4) made of a thermoplastic, the rim element (2) is formed in one piece together with the pressure spoke elements (3) and together with the hub element (4), wherein the hub element (4) has a hollow cylindrical hub sleeve (11), a internal diameter (D) of which is at least as large as a length (L) of the hub sleeve (11) in its axial direction.

11. The wheel (1) according to claim 10, wherein the extent of the internal diameter (D) of the hub sleeve (11) lies in the range of the factor 1.0 to 2.0 in relation to the length (L) of the hub sleeve (11).

12. The wheel (1) according to claim 10, wherein the hollow cylindrical hub sleeve (11) of the hub element (4) is adapted optionally to cooperate either with a drive shaft (20) or with a fixed wheel axle.

13. The wheel (1) according to claim 10, wherein at least one means (17) with which a torque can be transmitted is provided on the hub element (4).

14. The wheel (1) according to claim 13, wherein the means (17) for transmitting the torque comprises multiple threaded holes (15, 16), which are arranged distributed around the circumference of the hub sleeve (11) at an edge (18) of the hub element (4).

15. The wheel (1) according to claim 13, wherein the means (17) for absorbing a torque is adapted to fasten a drive shaft (20) to the hub element (4) and/or to fasten a brake disc to the hub element (4).

16. The wheel (1) according to claim 14, wherein the threaded holes (15, 16) are arranged in a metal element at the edge (18) of the hub element (4), and the metal element is integrated in the thermoplastic of the hollow wheel body (5).

17. The wheel (1) according to claim 1, wherein six pressure spoke elements (3) are provided.

18. A drive shaft (20) for a wheel (1) according to claim 1, wherein the drive shaft (20) is adapted for a one-sided mounting on a bicycle frame, or a one-sided rear wheel support of the bicycle frame.

19. The drive shaft (20) according to claim 18, wherein a gear wheel element (27) is arranged and configured to, cooperate with a drive means of a bicycle.

20. The drive shaft (20) according to claim 19, wherein the gear wheel element comprises a sprocket for a bicycle chain or a tooth lock washer (18) for a toothed belt or a gear wheel for the drive shaft.

21. The drive shaft (20) according to claim 19, wherein the drive shaft (20) comprises two shaft elements (23, 24), which are arranged and can be connected in a line.

22. The drive shaft (20) according to claim 21, wherein one shaft element is formed as a wheel support shaft element (23) and the other shaft element is formed as a supporting shaft element (24).

23. The drive shaft according to claim 21, wherein both shaft elements comprise complementary connection means (32, 34), which are adapted at least to transfer a rotational movement between the two shaft elements.

24. The drive shaft (20) according to claim 22, wherein the gear wheel element (27) is arranged on the wheel support shaft element (23).

25. The drive shaft (20) according to claim 20, wherein the gear wheel element (27) is integrated in one piece.

26. A bicycle component part from the group: wheel and drive shaft, the bicycle component part comprising a one-piece hollow body (5) with a component part wall (6) surrounding its cavity (7), wherein the component part wall (6) of the hollow body (5) is produced from a thermoplastic in a closed mould, wherein the component part wall (6) has a one-piece nature, which is produced by means of a rotational moulding in an externally heatable mould designed for the rotational moulding, a foam is arranged in the cavity (7), and that the foam extends at least partially as a foam layer (41) over the inside of the component part wall (6) or completely fills the cavity (7) as a foam filling (40, 41a) at least in regions.
